(19) United States
(12) Patent Application Publication
(10) Pub. No.: US 2019/0113192 A1
(43) Pub. Date: Apr. 18, 2019

(54) CHARGER COMPRISING NIGHT LIGHT

(71) Applicant: BRIGHTCHARGER EUROPE OY LTD, Kinkomaa (FI)

(72) Inventor: Harri TIAINEN, Kinkomaa (FI)

(73) Assignee: BRIGHTCHARGER EUROPE OY LTD, Kinkomaa (FI)

(21) Appl. No.: 16/087,655

(22) PCT Filed: Mar. 23, 2016
(86) PCT No.: PCT/FI2016/050188

§ 371 Date: Sep. 23, 2018

(51) Int. Cl. F21S 8/00; H05B 33/08; H05B 37/02; H02J 7/00

(52) U.S. Cl. CPC F21S 8/035; H02J 7/0052; H05B 37/0218; H05B 33/0854

(57) ABSTRACT

In an embodiment, a charger comprising a night light is described. In an embodiment, a device, comprises: a detector configured to detect a charging power of a battery of an electrical device and to determine a first and a second value of the charging power; a switch configured to connect and disconnect the charging; a controller configured to control the switch for disconnecting the charging when a relation between the first and the second value of the charging power exceeds a threshold for a period of time; and an illumination device comprising a night light configured to illuminate surroundings of the charger in dark or twilight circumstances, wherein the controller is further configured to control the night light for illuminating the charger on the basis of the relation.

### BACKGROUND

In recent decades, the number of different kinds of chargeable devices that are powered by electric current has grown enormously, and a single household may have for example 2-10 chargeable battery-operated devices. Such devices include for instance mobile phones, portable computers, electric toothbrushes and tablets. The devices may be charged on a continuing basis when stowed away, or when the battery needs to be charged. For example, in the case of mobile phones and tablets, charging may be repeated for example once a day or every other day. From the user's perspective, it requires effort to repeatedly monitor the filling or the charge percentage of the battery of a chargeable device, due to which the device may be charged for a considerably longer time than required to charge the battery full.

In general, devices to be charged are able to switch from using the charging current to the use of standby current, when the battery of a chargeable device becomes full. Although the standby current is considerably lower than charging current, on an annual level it still leads to significant electricity consumption. The charger also consumes current when left connected to the mains current, even if the charger was not connected to a chargeable device. This electricity consumption is completely useless and wasted energy. Scaling the problem up to a global level, electricity may be wasted by chargers to an extent that equals the production of several nuclear power plants. Furthermore, the standby current supplied by chargers to a chargeable device destroys or weakens the capacity of the battery of the chargeable device, speeding up the decrease of capacity of the battery. The batteries may have a certain life span of the available overall charging time.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In an embodiment, a charger comprising a night light is described. In an embodiment, a device, comprises: a detector configured to detect a charging power of a battery of an electrical device and to determine a first and a second value of the charging power; a switch configured to connect and disconnect the charging; a controller configured to control the switch for disconnecting the charging when a relation between the first and the second value of the charging power exceeds a threshold for a period of time; and an illumination device comprising a night light configured to illuminate surroundings of the charger in dark or twilit circumstances, wherein the controller is further configured to control the night light for illuminating the charger on the basis of the relation.

In other embodiments, a charger, a method and a computer program are discussed along with the features or the operations of the device.

Many of the attendant features will be more readily appreciated as they become better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 illustrates a schematic block diagram of a charger configured to charge a battery on the basis of a charging operation of the battery, wherein the charger comprises a night light according to an embodiment;

FIG. 2 illustrates current of a charger as a function of time when a night light is used according to an embodiment;

FIG. 3 illustrates current of a charger as a function of time when a night light is used and another charging operation is performed according to an embodiment;

FIG. 4 illustrates current of a charger as a function of time when a night light is used and the charger is unplugged before the charging has finished according to an embodiment;

FIG. 5 illustrates current of a charger as a function of time when a night light is used, the device is unplugged before the charging has finished, and another charging operation is performed according to an embodiment; and

FIG. 6 illustrates current of a charger as a function of time when a night light is automatically on for a period of time after charging has ended according to an embodiment.

Like numerical references are used to designate like parts in the accompanying drawings.

### DETAILED DESCRIPTION

The detailed description provided below in connection with the appended drawings is intended as a description of the present embodiments and is not intended to represent the only forms in which the present embodiment may be constructed or utilized. However, the same or equivalent functions and sequences may be accomplished by different embodiments.

Although the present embodiments may be described and illustrated herein as being implemented in a smartphone or a mobile phone and a respective charger, these are only examples of an electrical device having a battery to be charged by a charger, and not a limitation. As those skilled in the art will appreciate, the present embodiments are suitable for application in a variety of different types of battery operated devices that require charging, for example in tablets, phablets, computers, cameras, game consoles, laptop computers, domestic electrical devices, electrical toothbrushes, vacuum cleaners with battery, etc.

According to an embodiment, the charger detects charging power for at least two values and configures the charging based on the power. When a relation between the two values of the charging power has been under a certain threshold for a given time, the charging may be switched off. The charging power may be based on a charging current and/or a charging voltage. The charger may not restart without the activity of the user. Energy may be saved and the lifetime of the battery may be increased because unnecessary charging can be avoided. The charger comprises illumination having a night light and a charging light. The illumination is configured based on the charging. This may indicate to the user when charging is being conducted and operate as a night light for twilit or dark circumstances. The charger also has a user activation switch for activating the charging and for controlling the illumination.

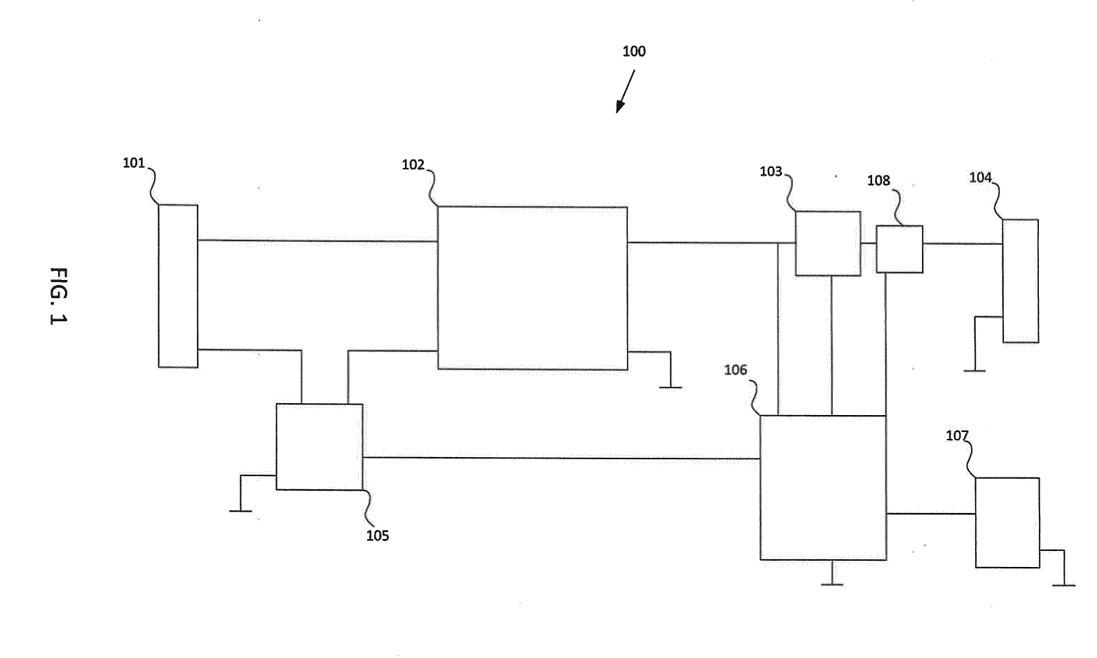

FIG. 1 illustrates a schematic block diagram of a charger 100 configured to charge a battery (not shown in FIG. 1) on the basis of a charging operation. The charger 100 comprises an illumination device 107 according to an embodiment.

The charger 100 comprises a reception 101. According to an embodiment, it may be an AC input of 230V. The reception 101 may be configured to receive electric current and accordingly electrical power energy from electric mains. The reception 101 is connected to a converter 102 and to a user switch 105. The charger comprises the converter 102. According to an embodiment, it may be an isolated component alternative current, AC, to direct current, DC, converter. According to an embodiment the converter 102 may convert from, for example 110V or 230V, AC to, for example 5V, DC. The converter 102 is configured to convert AC of the grid to DC for the battery. The converter 102 may comprise two AC inputs, a +5V output and a ground. The converter 102 is connected to the reception 101, to the user switch 105 and to a detector 103. The charger comprises the detector 103. The detector 103 is configured to detect charging of the battery. The detector 103 detects values for the charging. According to an embodiment, the detector 103 may be a current measurement resistor device, measuring resistance of the charging current. The detector 103 is connected to the converter 102, to another user switch 108, to a processor 106. The charger comprises the switch 108. The switch 108 is configured to switch the illumination device 107, such as the night light feature, on or off. According to an embodiment, the switch 108 may controlled by a tip of a pen, and it's a long term type of a switch. The switch 108 is connected to the detector 103, to the processor 106, and to a supply 104. The charger 100 comprises the supply 104 which is configured to supply the charging current to the battery. According to an embodiment, it may be a USB connector.

Referring to FIG. 1, the charger comprises the user switch 105. The user switch 105 is configured to trigger the start of the charging. Consequently, the charging process may not start before the user switch 105 has been activated. Furthermore, the user switch 105 is configured to trigger an illumination device 107 to be switched on. Consequently, the illumination device 107 may not be on before the user switch is activated. The user switch 105 may also switch the illumination device 107 off when receiving deactivation. The user switch 105 receives activation and de-activation made by the user. According to an embodiment, the user switch 105 may be a push button with auto return. According to an embodiment the user switch 105 may be configured so that a displacement of a cover of the charger 100 may act as the switch 105. For example, the user may push or touch a cover of the charger 100 for switching. According to an embodiment, the user switch 105 may be configured to the pins which enter the socket, so that user may switch the charger 100 may pressing the charger 100 against the socket. For another example, when the charger 100 is connected to the socket, the user may activate the switch 105 by pressing the charger 100 against to wall. The user switch 105 is connected to the reception 101, to the converter 102 and to the processor 106. The charger 100 comprises the processor 106. The processor 106 is configured to control the charging based on the detected value of the charging and/or the user switch 105. Furthermore, the processor 106 is configured to control the illumination device 107 based on the charging and/or the user switch 105. The processor 106 receives input signals from the user switch 105 and from the detector 103. The processor 106 outputs signals to the converter 102 for controlling the charging current. The processor 106 outputs signals to the illumination device 107. The processor 106 also controls the user switch 105. The processor 106 may switch the user switch 105 on and off. The processor 106 is connected to the converter 102, to the detector 103, to the other switch 108, to the user switch 105 and to the illumination device 107. The charger 100 comprises the illumination device 107. The illumination device 107 is configured to output night or twilit illumination, such as relatively low powered white light. Furthermore, the illumination device 107 is configured to output another kind of light such as green light for indicating the ongoing charging process. The illumination device 107 may comprise at least one LED and possibly a LED controller. The LED may be RGB LED or another kind of LED. Furthermore, the illumination device 107 may be other than LED.

According to an embodiment, the device 100 may operate only as a night light, even without the charging being operable, and have the light on/off switching. For example, when the electrical device to be charged is disconnected.

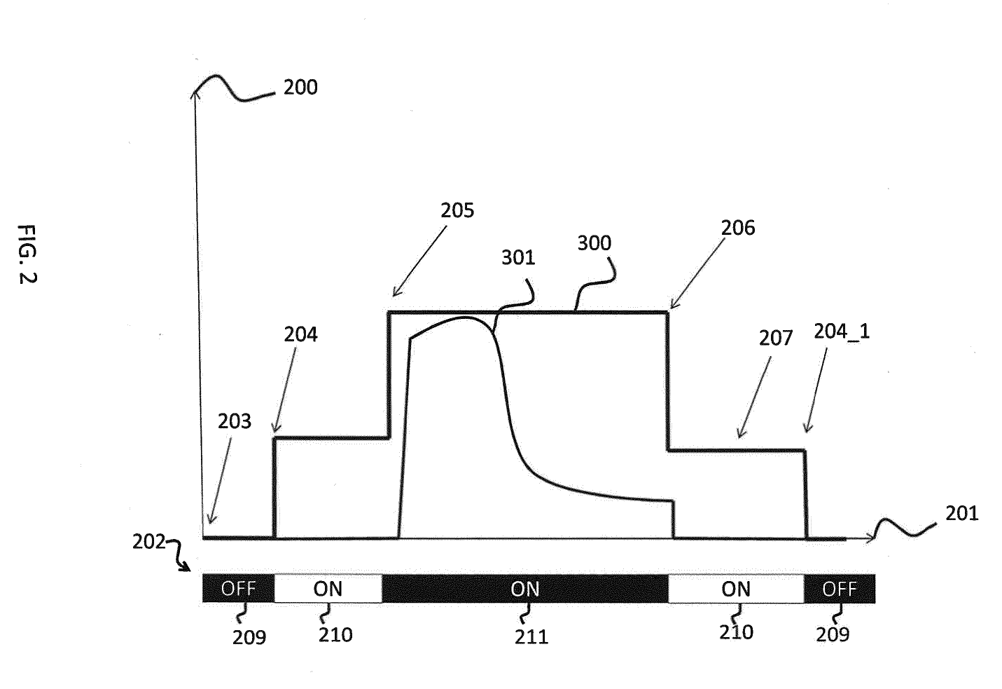

In the embodiments of FIGS. 2 to 6 overall current consumption and charging current are only schematically illustrated. Although the overall current consumption is schematically illustrated by a constant value, it may depend on the charging current, and consequently follow the charging current when the charging current is active. Furthermore the overall current consumption is illustrated for demonstration purposes only having a considerable difference to the charging current. According to an embodiment, the illumination current consumption makes only a small addition to the charging current consumption. For example, the overall current consumption comprising current consumption of the illumination and charging, wherein the illumination current consumption is very small in comparison to the charging current consumption.

FIG. 2 illustrates current 200 of a charger 100 as a function of time 201 when a night light is used according to an embodiment.

The current 200 is illustrated by the y-axis and the time 201 by the x-axis in the diagram of FIG. 2. Overall current consumption is illustrated by curve 300.

Curve 301 illustrates the charging current of the battery of the electrical device. At point 203, the charger 100 is plugged to the socket. For example, the user plugs the charger 100 to a wall socket of the mains electricity. The charging does not start. The illumination is not on as illustrated by reference 209. Thus illumination device 107 is switched off. The overall current consumption 300 is zero, thus charging current 301 being zero. At point 204, the user switch 105 is activated. For example, the user triggers the switch 105, such as pushes a button. This switches a night light 210 on by the illumination device 107. For example, the charger 100 emits white light for twilit or dark room. The overall current consumption 300 increases. At point 205, the charger 100 is connected to the electrical device. The electrical device is connected to the charger 100 via the supply 104. For example, the user connects a USB connector to a mobile phone. The charging process starts, and the charger 100 starts to charge the battery of the electrical device. The user switch 105 is thus activated at the point 205. After this, the charging current 301 first increases. The charging current 301 decreases in response to the charging process as illustrated by the curve 301. For example, the detector 103 monitors the charging current based on resistance, and the processor 106 sets the current level accordingly and controls the converter 102 for determining the charging current based on the detection. Furthermore, the processor 106 controls the illumination device 107 to turn on a light indicating that the charging process is ongoing as shown by reference 211, for example a green light is switched on. The overall current consumption is illustrated by curve 300 comprising the charging current 301 consumption and illumination current consumption. Although the overall current consumption 300 is schematically illustrated by a constant value in FIG. 2, it dependents on the charging current 301, and consequently the overall consumption 300 decreases along with the charging current 301. According to an embodiment, the processor 106 may switch the charging process off, when a relation between the first and the second value of the charging power exceeds a threshold for a period of time. According to another embodiment, in case when the chargeable device is turned off the current value has been under a predetermined value for a certain period of time, the processor 106 may switch the changing process off. The charging is now ready. This is illustrated by point 206. The charging current 301 is now switched off.

According to an embodiment, the detector 103 is configured to detect a charging power of the battery of an electrical device and to determine a first and a second value of the charging power. The controller 106 is configured to control the switch 105 for disconnecting the charging when a relation between the first and the second value of the charging power exceeds a threshold for a period of time. According to an embodiment, the current value of the charging current may be compared to a charging current value, which is determined earlier in the charging process. For example current charging current value is compared to a previous value, which is determined relatively close to the current point of time up to several hours before the current point of time, depending on the charging process and other parameters. Furthermore, a relation may be calculated from these values for a certain period of time. The certain period of time may prevent any false detection, in case a very rapid power changes in the charging process.

Furthermore at the point 206, the processor 106 controls the illumination device 107 to change illumination from the charging illumination 211 to the night light illumination 210. For example, the illumination changes from green to white light. Consequently, the overall current consumption 300 decreases and is only based on the night light illumination 210. At point 207, the charger 100 is unplugged from the electrical device. For example, the user unplugs the USB cable. This does not, however, affect the night light illumination 210, which remains on. At point 204_1, the user deactivates the charger 100 by the user switch 105. For example, the user presses the button. The processor 106 switches off the night light 210 of the illumination device 107. The overall current consumption 300 drops to zero.

The charging does not start before the user activates the charger 100. Furthermore, the night light is not switched on prior to the activation. Consequently, the charger saves energy. The energy consumption is zero or substantially zero when the charger 100 is not activated, even when the charger 100 is plugged to the socket. The charging process may be performed in response to the battery's capability to be charged. The charging process can be switched off automatically when the charging cycle has finished and the battery is full. There is no waste of energy, and battery life time is also saved as short repeating pumping charging cycles are avoided, even when the battery is full. Furthermore, the illumination automatically follows the charging cycle; when the charging is on, the illumination is indicating the charging process. When the charging process has finished, the illumination automatically switches to the night light mode. For energy saving reasons or for usability, the night light may be switched off, even when the charger 100 is plugged to the socket.

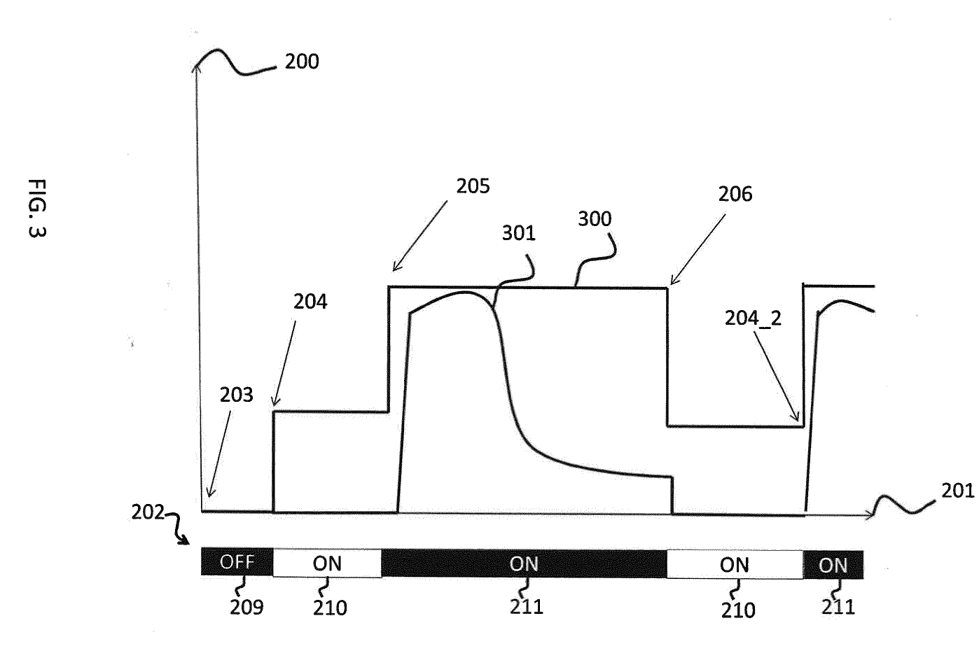

FIG. 3 illustrates current 200 of a charger 100 as a function of time 201 when a night light is used and another charging operation is performed after a first charging operation has been finished according to an embodiment. The embodiment of FIG. 3 is similar to the embodiment of FIG. 2 for points 203,204,205,206. The charging is ready at point 206. At point 204_2, the user activates the charger 100. The user activates the user switch 105. The charging process re-starts for another charging process, and the illumination is automatically switched to the charging illumination 211.

The user may re-activate the charging process, for example to ensure that the battery is full, or in case there has been battery consumption after finishing the first charging process. The illumination automatically follows the charging process.

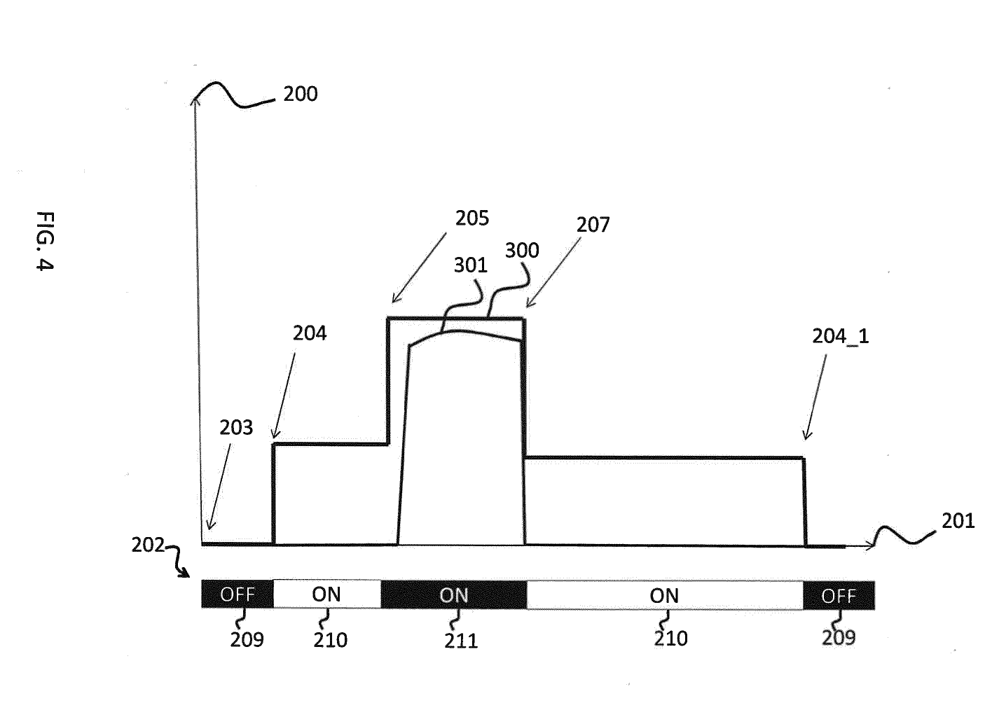

FIG. 4 illustrates current 200 of a charger 100 as a function of time 201 when a night light is used and the charger is disconnected before the charging has finished according to an embodiment.

The embodiment of FIG. 4 is similar to the embodiment of FIG. 2 for points 203,204,205. At point 207, the charger 100 is disconnected from the electrical device. For example, the USB cable with the USB connection is disconnected. The charging process is naturally terminated, as illustrated by curve 301 in FIG. 4. The processor 106 switches the illumination device 107 from the charging illumination 211 to the night light illumination 210. The night light illumination 210 remains on until the user de-activates it at point 204_1.

The illumination may automatically follow the charging process. The user is able to activate and de-activate the illumination. The illumination may act as a night light even without the charging process.

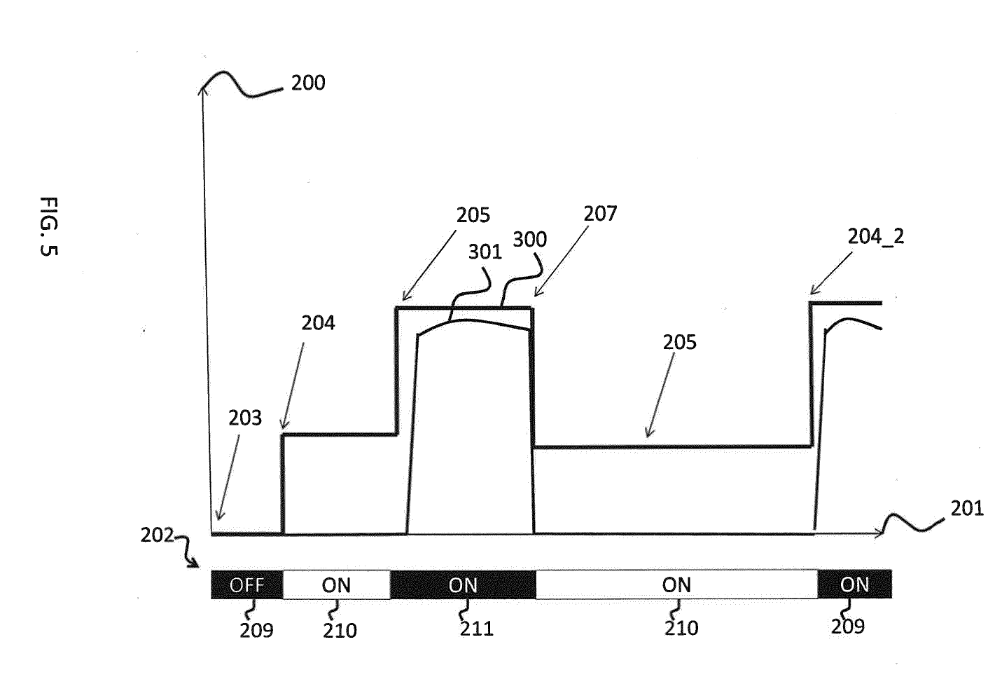

FIG. 5 illustrates current 200 of a charger 100 as a function of time 201 when a night light is used. The charger 100 is unplugged before the charging process has finished and another charging operation is performed according to an embodiment. Thus the charger 100 is disconnected from the electrical device to be charged. The charger 100 may be maintained at the socket, for example as a default choice, and only the USB cable connecting the charger 100 to the chargeable device 100 is disconnected.

The embodiment of FIG. 5 is similar to FIG. 4 for points 203,204,205,207. At point 205, the charger 100 is re-connected to the electrical device after it has been disconnected at point 207. The charging process does not start. The night light illumination 210 remains on. At point 204_2, the user activates the user switch 105. The charging re-starts and the illumination changes from the night light 210 to charging illumination 211.

Despite the charger 100 being connected to the electrical device at point 207, the charging starts after the user has activated the charger. The charging process may also re-start and is configured according to the capacity of the battery. Consequently, re-start needs user activation. According to an embodiment, the charger 100 may act as a night light having on/off switch, when charging process is not activated.

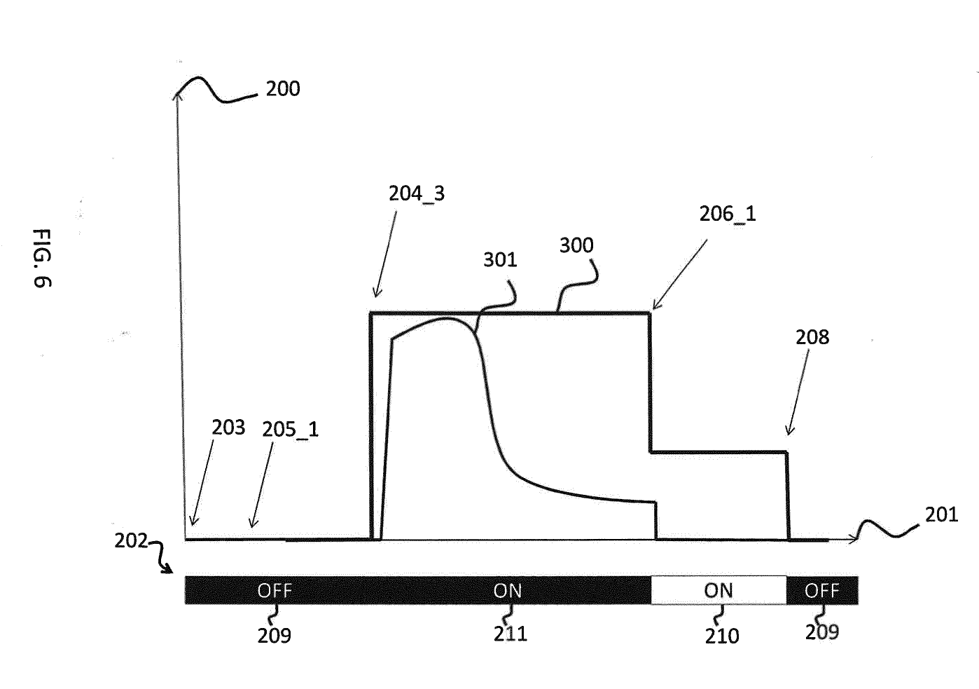

FIG. 6 illustrates current 200 of a charger 100 as a function of time 201 when a night light is used so as to be automatically switched on after the charging has finished according to an embodiment.

At point 203, the charger 100 is plugged to the socket. The charging does not start. The illumination is not on as illustrated by reference 209; thus, the illumination device 107 is switched off. The overall current consumption 200 is zero. At point 205_1, the charger 100 is connected to the battery. The connector 104 is connected to the electrical device. However, the charging does not start. The illumination is not on as illustrated by reference 209. The overall current consumption 200 is zero. At point 204_3, the user activates the charger 100. The user activates the user switch 105. The charging process starts as illustrated by the charging current 301. The illumination switches directly to charging illumination 211. At point 206_1, the charging process is ready. According to an embodiment, the night light 210 may be automatically switched on by the processor 106 after the charging is ready for a predetermined period of time. For example, it may be on for one hour. After the predetermined period has lapsed, the processor 106 switches the night light 210 off at point 208. Consequently, the electric consumption is zero.

According to an embodiment, the charger 100 may optionally comprise a super capacitor storing an amount of electrical energy. The super capacitor may be configured to feed power to the illumination device 107 for example to the night light, when the mains supply is disturbed, for example during a power outage. Consequently, the charger 100 may be illuminated for a short period of time, when the power outage takes place. This may provide user with convenience and safety.

The functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Alternatively, or in addition, the functionalities described herein may be operated by software in machine readable form on a tangible storage medium e.g. in the form of a computer program comprising computer program code means adapted to perform all the functions and the steps of any of the methods described herein when the program is run on a computer and where the computer program may be embodied on a computer readable medium.

Examples of tangible storage media include computer storage devices comprising computer-readable media such as disks, thumb drives, memory etc. and do not include propagated signals. Propagated signals may be present in a tangible storage medium, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Any range or device value given herein may be extended or altered without losing the effect sought. Also any embodiment may be combined to another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as embodiments of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought, or without extending beyond the disclosure.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A device, comprising:
a detector configured to detect a charging power of a battery of an electrical device and to determine a first and a second value of the charging power;
a switch configured to connect and disconnect the charging;
a controller configured to control the switch for disconnecting the charging when a relation between the first and the second value of the charging power exceeds a threshold for a period;
an illumination device comprising a night light configured to illuminate surroundings of the charger in dark or twilit circumstances, wherein the controller is further configured to control the night light for illuminating the charger on the basis of the relation; and also a user switch configured to control the night light for switching the night light on and off based on activation by a user of the charger so that the illumination device may not be on before the user switch is activated.

2. The device of claim 1, wherein the user switch is configured to also switch the charging on.

3. The device of claim 1, wherein the charging starts when the user switch is activated, the charger is plugged in a socket and connected to the battery of the electrical device.

4. The device of claim 1, wherein the controller is configured to connect the switch after receiving the activation of the user switch.

5. The device of claim 1, wherein, when the switch is disconnected and the illumination device is switched off, the charger does not consume power.

6. The device of claim 1, wherein the charging power is based on a charging current; or wherein the charging power is based on a charging voltage.

7. The device of claim 1, wherein the detector configured to detect the charging power on a basis of a low voltage connection between the device and the battery.

8. The device of claim 1, wherein the detector configured to detect the charging power on a basis of a high voltage connection between the device and mains.

9. The device of claim 1, wherein the first value comprises a current value of the charging power and the second value comprises a previous value of the charging power.

10. The device of claim 1, wherein the controller is configured to switch the night light on when the charging is disconnected; or
wherein the controller is configured to switch the night light off when the charging is connected.

11. The device of claim 1, wherein the illumination device further includes a charging light, wherein the controller is configured to switch the charging light on when the charging is on.

12. The device of claim 1, wherein the controller is configured to switch the charging light off when the charging is off.

13. A charger, comprising the device according to claim 1, configured to charge the battery of the electrical device.

14. A method, comprising:
detecting, by a detector, a charging power of a battery of an electrical device and determining a first and a second value of the charging power;
connecting and disconnecting, by a switch, the charging;
controlling, by a controller, the switch for disconnecting the charging when a relation between the first and the second value of the charging power exceeds a threshold for a period of time;
illuminating, by an illumination device comprising a night light, surroundings of the charger in dark or twilit circumstances, wherein the controller further
controls the night light for illuminating the charger on the basis of the relation; and
switching, by a user switch, the night light on and off based on an activation by a user of the charger so that the illumination device may not be on before the user switch is activated.

15. A computer program, comprising code configured to perform the operations of the method of claim 14.

16. (canceled)
